(19) United States
(12) Patent Application Publication
(10) Pub. No.: US 2007/0110927 A1
(43) Pub. Date: May 17, 2007

(54) Non-threaded expandable pipe connection system

(76) Inventors: Philip Head, Surrey (GB); Paul George Lurie, Surrey (GB)

Correspondence Address: NIXON & VANDERHYE, PC, 901 NORTH GLEBE ROAD, 11TH FLOOR, ARLINGTON, VA, 22203, US

(21) Appl. No.: 10/584,128

(22) PCT Filed: Dec. 8, 2004
(86) PCT No.: PCT/GB04/05137

§ 371 Date: Jun. 23, 2006

(30) Foreign Application Priority Data
Dec. 23, 2003 (GB) 0329811.4
May 14, 2004 (GB) 0410906.2

(51) Int. Cl. B05D 1/08; B31B 45/00

(52) U.S. Cl. 428/34.1; 427/446

(57) ABSTRACT

A method for connecting tubular elements (37,40), particularly pipe for strings to be used in oil and gas wells, comprises: (A) locating a portion of a first tubular element (37) within a portion of a second tubular element (40), (B) expanding the portion of the first tubular element and/or compressing the portion of the second tubular element to form a connection resulting from the interference between the external surface of the portion of the first tubular element and the internal surface of the portion of the second tubular element, in which, prior to assembly, one or both of the external surface of the portion of the first tubular element and the internal surface of the portion of the second tubular element is/are at least partially coated by plasma spraying with hard angular material. Preferably, protuberances (38) of plasma-sprayed hard angular material are formed on at least one of the mating surfaces of the connection.

The present invention relates generally to methods and apparatus for the connection of piping. More specifically, the present invention relates to methods and apparatus for connection of piping used on oil and gas wells and in particular to piping that is expanded radially to form an increased internal diameter pipe string.

In order to access hydrocarbons in subsurface formations, it is generally necessary to drill a bore into the earth. The process of drilling a borehole and subsequently completing the well and producing oil or gas from the well requires the use of various tubular strings, such as the drill string, casing string, production tubing and sandscreens. These tubular strings comprise lengths of tubular elements connected together at their ends. Conventionally, the tubular elements or pipes are connected together by threaded connections. Typically, the tubular elements are approximately 30 to 40 feet (9 to 12 m) in length, and have a threaded male “pin” connection at one end and a threaded female “box” connection at the opposite end. The lengths of pipe are connected together, or “made up” by inserting, or “stabbing” the pin into the box and applying torque to one of the lengths of pipe while the other is held stationary. Such connections are usually made pin down and box up. The lengths of pipe may be formed with a pin at each end, in which case the box connection can be formed by a short female/female coupling screwed onto one pin connector. The box may be integrally formed with the pipe. The box may be radially larger than the external body of the pipe, i.e. “upset”, or may have substantially the same external diameter, i.e. “flush”. Sometimes relatively long lengths of coiled tubing are used. These are generally also connected together or to short lengths of pipe by pin and box threaded connectors.

The integrity of the connections is important, as it can cause serious difficulties if they fail downhole. Also, there is often a need to seal the connections. Numerous thread designs have been developed and used, ranging from low cost tapered round thread, stub acme and multi-stepped. Similarly various seals have been used such as face seals, elastomer O-rings and metal-to-metal seal arrangements.

A technique for casing a well comprises expanding the casing string after it has been lowered into the wellbore. This allows subsequent strings of pipe to be lowered through previously installed casing and thereafter expanded. It is possible, by using this technique, to install casing having a substantially uniform internal diameter, i.e. a “monobore” casing.

The conventional pin and box threaded connections generally provide an effective and secure mechanical connection that holds the tubular string together and seals the connection when the strings are not to be expanded. However, such connections, when subjected to expansion, change dimensionally in ways that can result in unsatisfactory engagement and sealing. Conventional pin and box threaded connectors may for instance disengage allowing the lower tubing to fall into the wellbore. The radial expansion of a conventional pin and box threaded connector can also result in failure of the sealing arrangement due to the resulting distortion. It is also possible that radial expansion of a conventional pin and box threaded connector may result in the box splitting along its length.

There is therefore a need for an improved method and apparatus for connecting tubular elements, particularly tubular elements that will subsequently be subjected to radial expansion. The connections should preferably be capable of resisting tensile loads and torque and be gas tight even after radial expansion from as little as 5% to as much as 50%.

According to the present invention, a method for connecting a first tubular element and a second tubular element comprises:

locating a portion of the first tubular element within a portion of the second tubular element,

expanding the portion of the first tubular element and/or compressing the portion of the second tubular element to form a connection resulting from the interference between the external surface of the portion of the first tubular element and the internal surface of the portion of the second tubular element,

in which, prior to assembly, one or both of the external surface of the portion of the first tubular element and the internal surface of the portion of the second tubular element is/are at least partially coated by plasma spraying with hard angular material.

This method enables the tubular elements to be connected together without the use of a screw thread. Although, the connections according to the present invention can be made by expanding the first tubular element or compressing the second tubular element or both, it is generally easier to form the connections by increasing the diameter of the first tubular element. Any suitable method can be used to expand the first tubular element or compress the second tubular element. Preferably, the first tubular element is expanded by forcing a mandrel through the portion to be expanded, using a radially expandable conventional expander or by passing a swaging means through the first tubular element. A particularly suitable expansion means comprises a device having means for radially extending rollers or balls that swage the tubular element as the device is moved through the first tubular element.

Methods for plasma spraying are known. Plasma is the term for gas that has been raised to such a high temperature that it ionises and becomes electrically conductive. When Plasma spraying, the plasma is created by an electric arc within the nozzle of the gun. The gas is formed into a plasma jet as it emerges from the gun nozzle. Powder particles are injected into this jet where they can soften and then strike the surface being coated with high velocity.

The person skilled in the art will readily be able to select a hard angular material for use in the plasma-spraying step of the present invention. Suitable materials include, for example, chromium and tungsten.

The external surface of the portion of the first tubular element and/or the internal surface of the portion of the second tubular element may be completely plasma spray coated and this coating may be of substantially uniform depth. However, it has been found that particularly good connections can be formed by plasma spraying the external surface of the portion of the first tubular element and/or the internal surface of the portion of the second tubular element to form protuberances on the surface. This can be achieved, by the use of suitable masking means, such as, for example, by placing a foraminous mask over the surface before plasma spraying, such that the plasma spray passes through the holes in the mask where it deposits and bonds to the surface of the tubular element. When the mask is removed, there are protuberances of plasma-sprayed hard angular material where the holes had been in the mask and the rest of the surface remains uncoated. In another method for preparing the protuberances, imperforate masking may be used to form a pattern of holes through which the plasma may be sprayed onto the surface of the tubular element to form the protuberances of hard angular material. For example, strips of imperforate masking material can be arranged over the surface to be sprayed and then removed after spraying to reveal the protuberances. Aluminium sheet may suitably be used to form the mask. Preferably, the mask comprises a sheet of aluminium in which a plurality of holes have been formed. The holes may be of any shape, but are conveniently circular. Typically, the protuberances are of the order of about 1 mm in height, although the actual size can vary depending on the size and application of the tubular elements. Protuberances of relatively greater height may be used where the tubular elements have a large diameter and/or are to be expanded at a greater ratio. Relatively smaller heights may be more suitable for the protuberances where the difference between the initial internal diameter of the second tubular element and the initial external diameter of the first tubular element is relatively small.

The protuberances may be formed on the metal surface of the tubular element; the uncoated surface remaining bare metal. If desired, a further plasma coating may then be sprayed over the portion of the tubular element. In another embodiment, the surface of the portion of the tubular element can be coated by plasma spraying to a substantially uniform thickness and then a mask applied over the plasma-sprayed coating and then plasma sprayed to form the protuberances.

Preferably, part of the portion of the first tubular element and a corresponding part of the portion of the second tubular element are not coated by plasma spraying such that when the connection is expanded these bare metal parts form a metal-to-metal connection that can provide a more effective seal.

The method of the present invention is particularly suitable for connection of piping used on oil and gas wells and in particular to piping that is expanded radially to form an increased internal diameter pipe string. In such applications, the expansion to form the connection may be made at the surface or downhole. Preferably, the connections are at least partially expanded at the factory or at the rig floor. After the string is lowered into the borehole the connections may be further expanded. Where the connections are used on tubulars that are to be radially expanded downhole, the connections are preferably expanded sufficiently at the surface to ensure that they do not separate as the string is lowered into position and are then further expanded when the tubular is expanded downhole.

Expansion of the first tabular element and/or compression of the second tubular element forces the protuberances against the opposing surface. For example, in a preferred embodiment of the present invention, plasma-sprayed protuberances are formed on the external surface of the portion of the first tubular element, the portion of the first tubular element is located within a portion of the second tubular element and the portion of the first tubular element is expanded to form a connection resulting from the interference between the surface of the expanded portion of the first tubular element and the internal surface of the second tubular element. The expansion of the first portion forces the protuberances on the portion of the first tubular element against the internal surface of the portion of the second tubular element.

Preferably, the expansion of the portion of the first tubular element also results in expansion of the portion of the second tubular element. The materials and dimensions of the portions of the tubular elements are selected such that after expansion there is an interference fit between the mating surfaces of the portions.

The expansion preferably results in the protuberances causing distortion of the opposing surface. In the preferred embodiment where there are protuberances on the external surface of the first tubular element, the protuberances preferably cause deformation in at least the internal surface of the portion of the second tubular element and possibly deformation of both the internal and external surfaces of the portion of the second tubular element. This deformation increases the ability of the connection to resist tensile forces and torque and thereby reduces the risk of the connection being pulled or twisted apart.

Part of one or both of the external surface of the portion of the first tubular element and the internal surface of the portion of the second tubular element can be treated by plasma spraying soft material and/or by depositing an elastomeric coating in order to improve the sealing of the connection.

The portions of the first tubular element and second tubular element have complementary shapes to enhance the seal and tensile strength of the connection. Typically, the external surface of the portion of the first tubular element and the internal surface of the portion of the second tubular element are substantially cylindrical or have a similar taper. They may have a stepped, tapered construction, provided that there is sufficient land on one or more of the steps to provide sufficient surface for the plasma sprayed hard angular material. Such a stepped tapered connection may be particularly useful for a flush jointed connection.

The first and second tubular elements can be any of the tubulars used in drilling and completing oil and gas wells, including drill pipe, casing, production tubing and sandscreen. Typically these are lengths of pipe from 9 to 12 m. The invention can also be used for longer lengths of pipe, such as coiled tubing. The present invention can also be used to make connections in which one of the first tubular element and second tubular element is a relatively short tubular coupling. For example, the first tubular element can be a relatively short coupling having at each end a male tubular connector (or “pin”). Each pin can be located within a female portion (or “box”) of each of two second tubular elements. In another embodiment the relatively short tubular coupling has at each end a female connector into each end of which can be located the male portion of each of two first tubular elements. A stronger connection can be made by connecting two pipes using both a male/male coupling and a female/female coupling.

The torque and tensile load capacity of the connections can be increased by incorporating, between the mating surfaces of the connection, elements designed to be embedded in the surfaces as the connection is expanded. For example, the present invention includes a method of joining tubulars in which a helical element, such as, for example, the commercially available thread inserts supplied under the trade name Helicoil, is inserted between the surfaces before expansion of the connector. As another example, rings of relatively hard material may be positioned between the surfaces of the tubular elements prior to expansion. A further example is to position lengths of a relatively hard material along the length of the connection, preferably substantially axially with respect to the longitudinal axis of the tubular string. In a further embodiment, the elements designed to embed in the mating surface can be integrally formed on the portion of one or other of the tubular elements.

The present invention includes tubular elements for use in the method of connecting tubular elements to form a string. In particular, the present invention includes an expandable tubular element having protuberances on a part of its surface adjacent at least one end thereof which have been formed by plasma spraying a hard angular material.

The tubular elements according to the present invention can be tubular elements having pin and/or box connectors in which the plasma-sprayed protuberances are on the external surface of the pin connector and/or the internal surface of the box connector. Each tubular may have two pin connectors, two box connectors or one of each. A preferred apparatus for connecting two elongate cylindrical tubular elements comprises (i) a relatively short male/male coupling comprising two pins, the external diameters of the pins being smaller than the internal diameters of the elongate cylindrical tubular elements and the pins having plasma-sprayed protuberances on at least part of their external surface and (ii) a relatively short female/female coupling comprising two boxes, the internal diameters of the boxes being larger than the external diameters of the elongate cylindrical tubular elements and the boxes having plasma-sprayed protuberances on at least part of their internal surface.

Although any of the known methods of radially expanding tubular elements can be used to form the connections of the present invention, a preferred method is to use a rotating ball expander. Such devices are known and comprise radially extendible rotatable balls. The balls are urged outwardly against the wall of the tubular element and then the balls are rotated around the internal surface of the tubular element and are also moved axially along the portion of the first tubular element so that they describe a helical path and form a helical depression in the material of the first tubular. The helical depression on the internal surface of the first tubular preferably causes a similar distortion of the external surface of the first tubular element and more preferably causes a similar distortion of the second tubular. This arrangement can increase the resistance of the connection to collapse. If desired, this helical swaging can be used along the whole length of the tubular string.

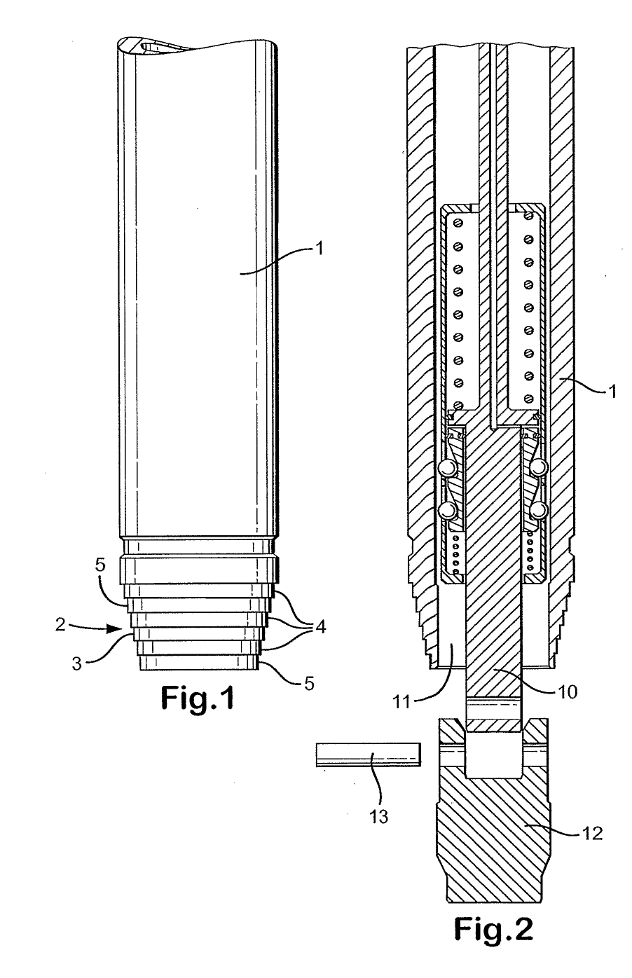

Embodiments of the present invention are illustrated in the accompanying FIGS. 1 to 35, in which:

FIG. 1 shows an external side view of a first tubular element having a stepped, tapered pin end.

FIGS. 2 to 8 are cross-sectional views of apparatus showing how the first tubular element illustrated in FIG. 1 can be connected to a second tubular element having a stepped, tapered box end to form a flush connection.

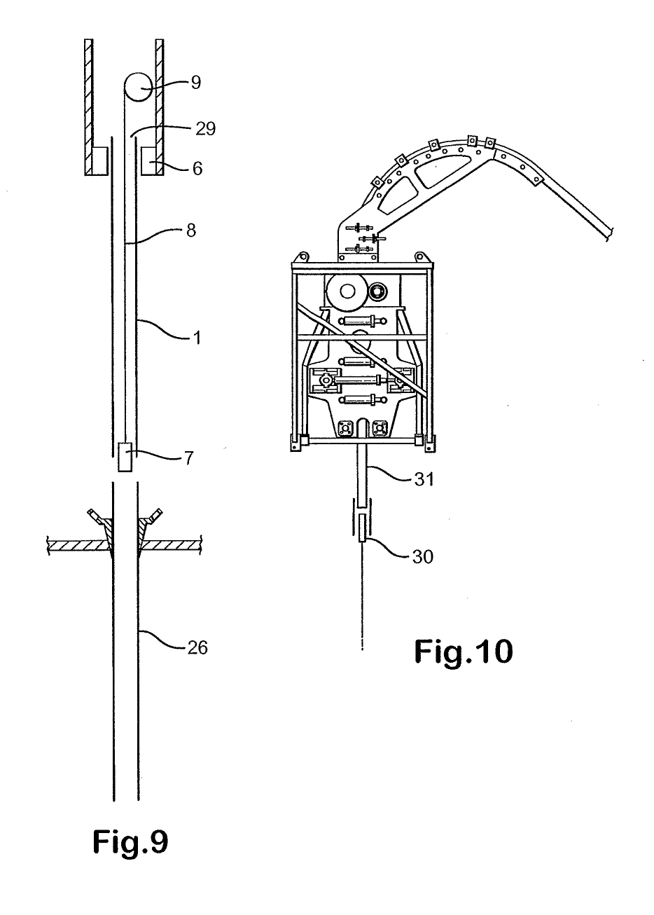

FIG. 9 is a schematic representation of equipment that could be used on an oil or gas rig to assemble lengths of pipe for connection.

FIG. 10 is a schematic representation of equipment that could be used for handling coiled tube.

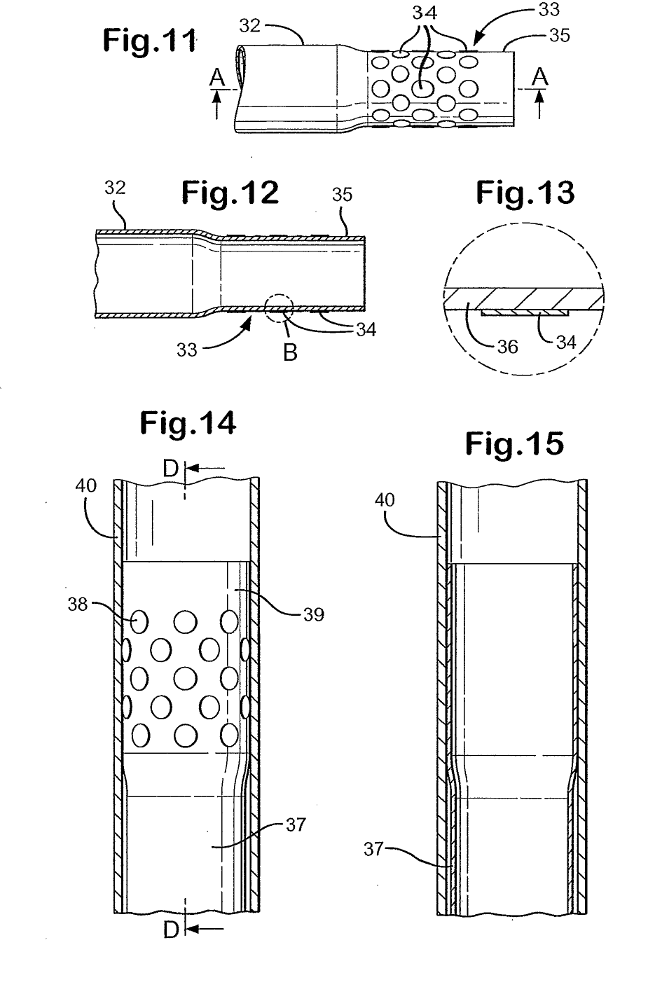

FIG. 11 is an external side view of a first tubular element having a pin connector the external surface of which has plasma-sprayed protuberances.

FIG. 12 is a cross-section taken along A-A of the first tubular element illustrated in FIG. 11.

FIG. 13 is an enlarged cross section of the part identified as B in FIG. 12.

FIG. 14 illustrates the external side view of a first-tubular element installed within a second tubular element, which is shown in cross-section

FIG. 15 is a sectional side view taken on D-D of FIG. 14, showing the first tubular element expanded into the internal surface of the of second tubular element to form a connection.

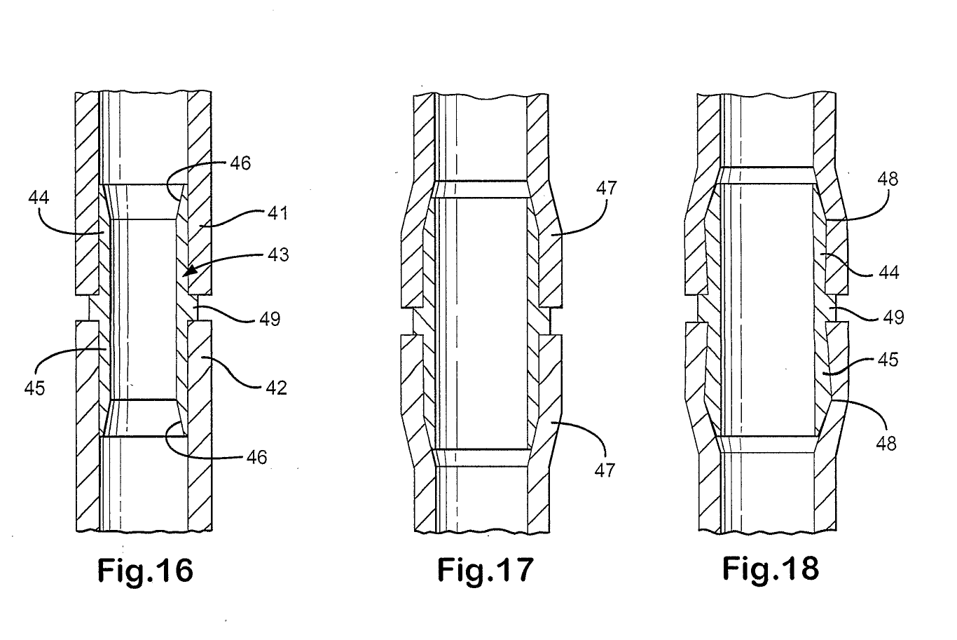

FIG. 16 is a schematic sectional view of another embodiment of apparatus for forming a connection according to the present invention, utilising a male/male coupling.

FIG. 17 is a schematic sectional view of the apparatus illustrated in FIG. 16 after expansion of the connection.

FIG. 18 is a schematic sectional view of another embodiment of a connection according to the present invention, after expansion.

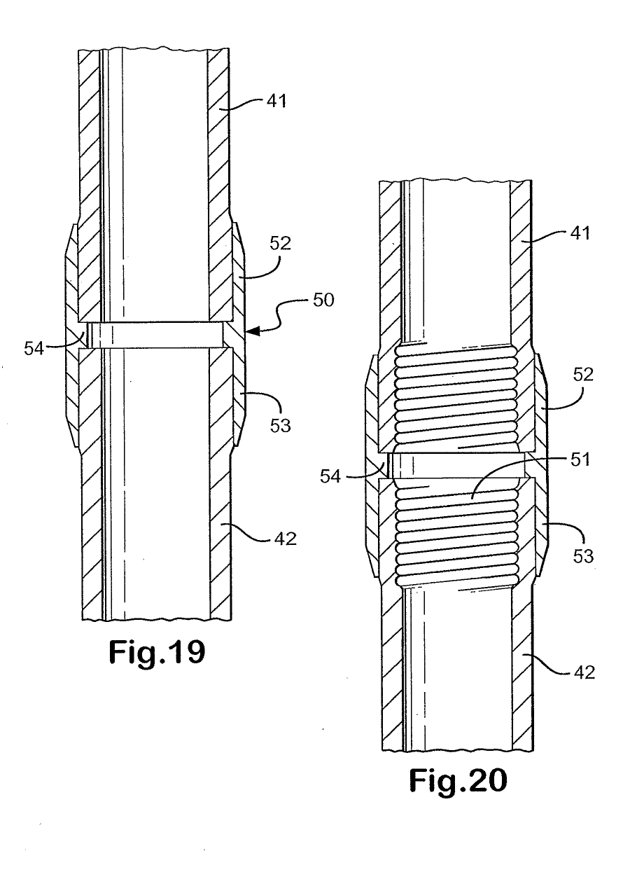

FIG. 19 is a schematic sectional view of another embodiment of a connection according to the present invention, using a female/female coupling.

FIG. 20 is a schematic sectional view of the apparatus illustrated in FIG. 19 after expansion of the connection which has resulted in a helical groove being formed as the connection was expanded.

FIG. 21 is a schematic sectional view of another embodiment of a connection according to the present invention, using both a male/male coupling and a female/female coupling.

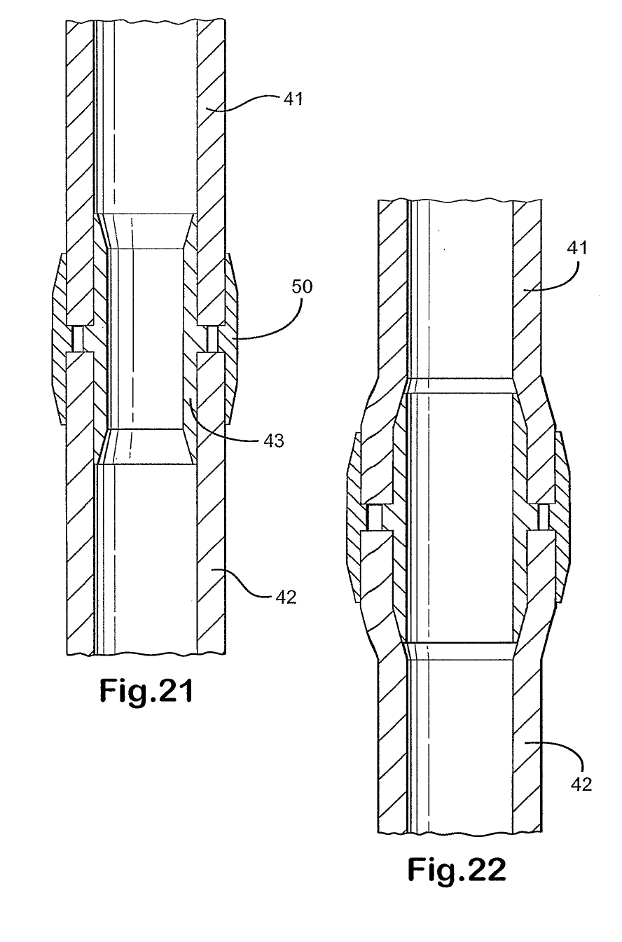

FIG. 22 is a schematic sectional view of the apparatus illustrated in FIG. 21 after expansion of the connection.

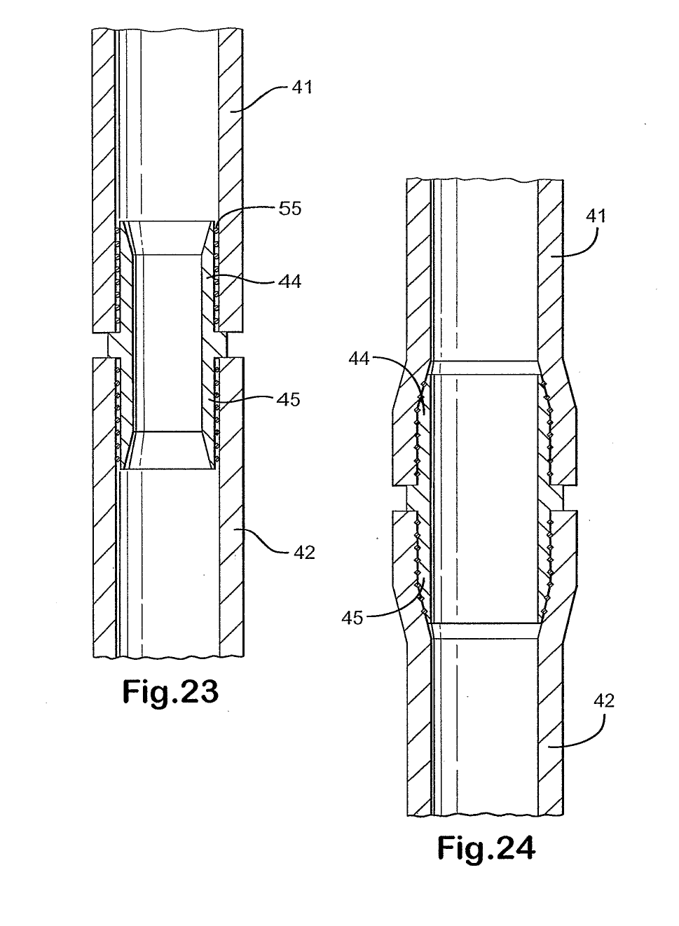

FIG. 23 is a schematic sectional view of another embodiment of apparatus for forming a connection according to the present invention, utilising a male/male coupling similar to that shown in FIG. 1 6 except that helical thread inserts are positioned between the mating surfaces of the connection prior to expansion.

FIG. 24 is a schematic sectional view of the apparatus illustrated in FIG. 23 after expansion of the connection.

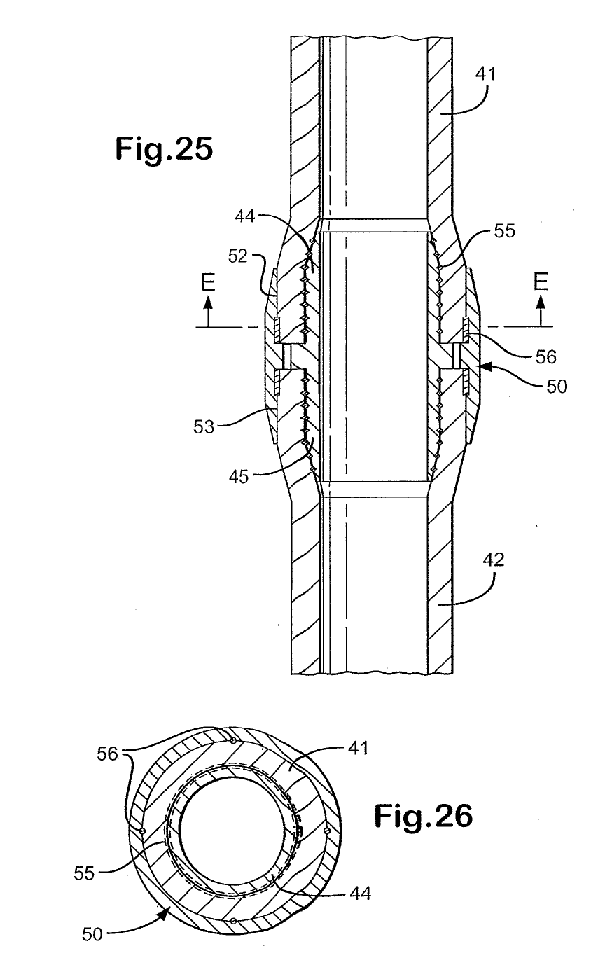

FIG. 25 is a schematic sectional view of another embodiment of a connection according to the present invention, using both a male/male coupling and a female/female coupling after expansion similar to that shown in FIG. 22 except helical thread inserts are positioned between the mating surfaces of the pins of the male/male coupling and the internal surfaces of the pipes being connected and that axial inserts are positioned between the boxes of the female/female coupling and the external surfaces of the pipes being connected.

FIG. 26 is a cross-sectional view of the apparatus illustrated in FIG. 25 along E-E.

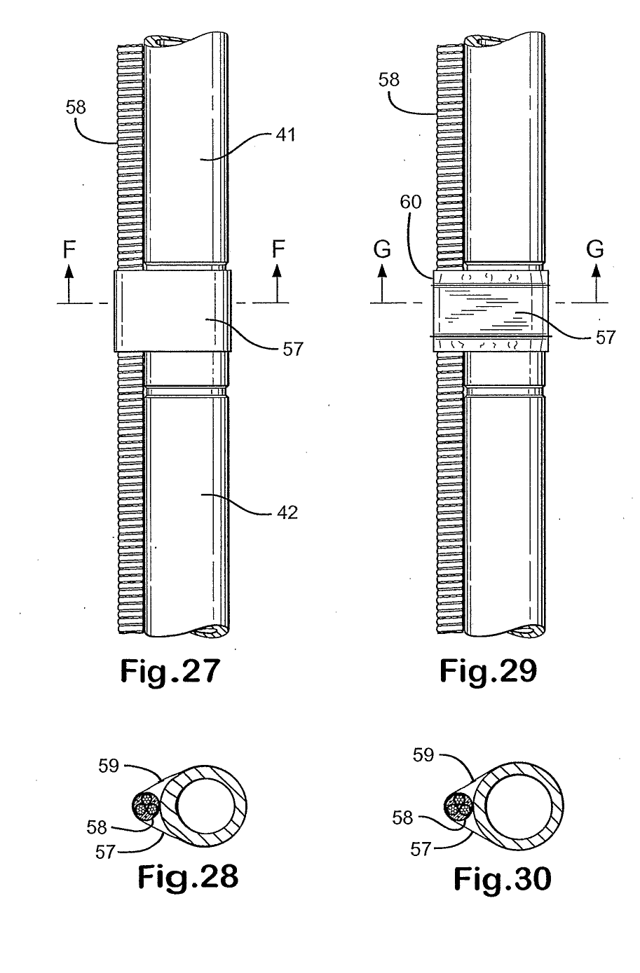

FIG. 27 shows a side view of an over-coupling protector, an external cable and two tubular elements prior to expansion of the connection.

FIG. 28 shows a section view on F-F of the apparatus illustrated in FIG. 27.

FIG. 29 shows the apparatus illustrated in FIG. 27 after expansion of the connection.

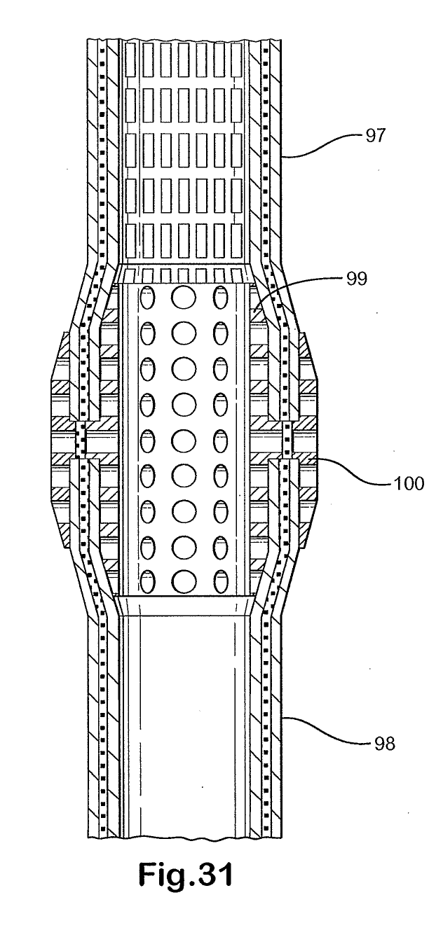

FIG. 30 shows a section view on G-G of FIG. 29.

FIG. 31 is a sectional side view of an embodiment of a connector applied to a sandscreen.

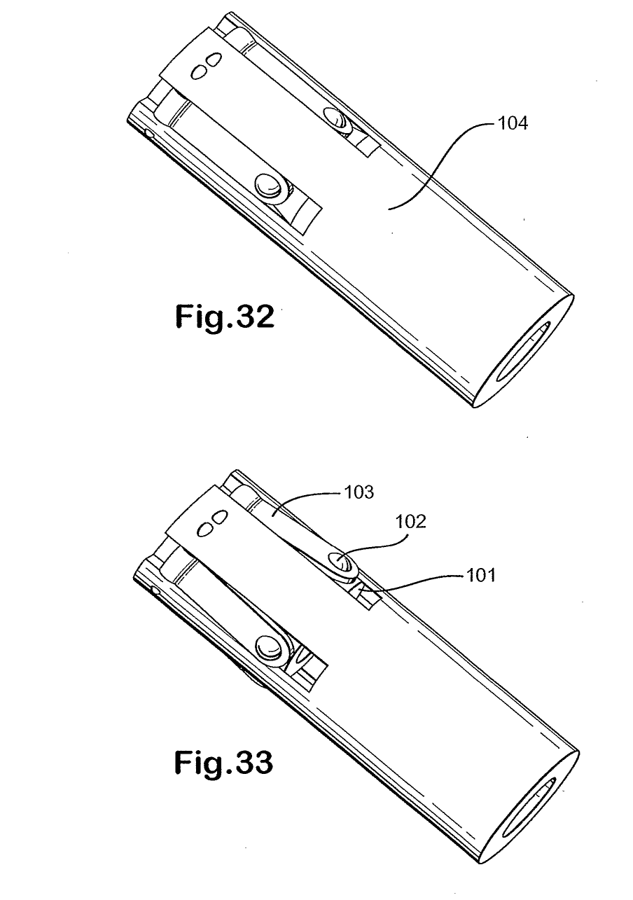

FIG. 32 is an isometric view of a ball bearing roller expander in its undeployed mode.

FIG. 33 is an isometric view of a ball bearing roller expander in its deployed (radially expanded) mode.

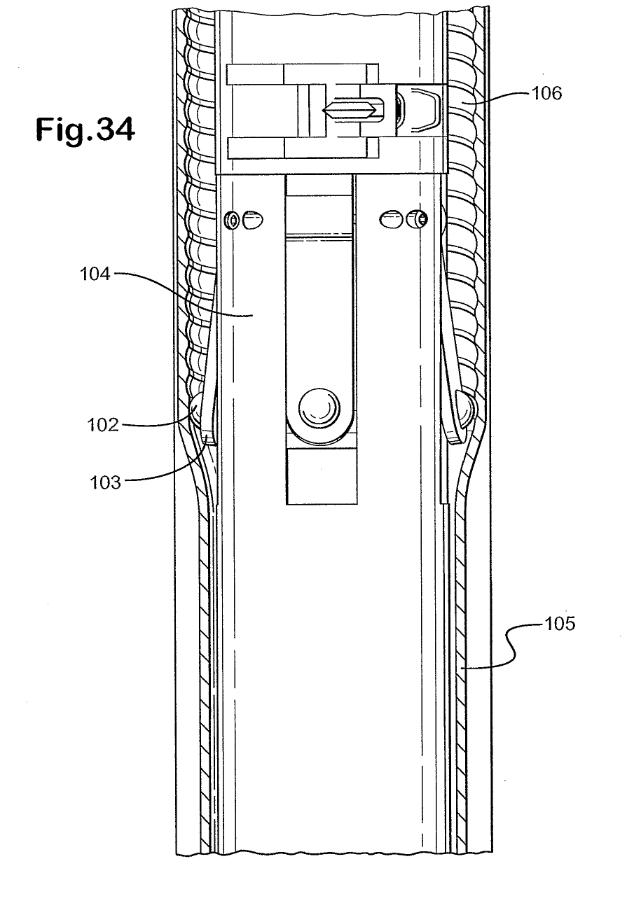

FIG. 34 is a view of the ball bearing roller expander illustrated in FIGS. 32 and 33 in operation, expanding and deforming the wall of a tubular element; the tubular element being shown in cross section.

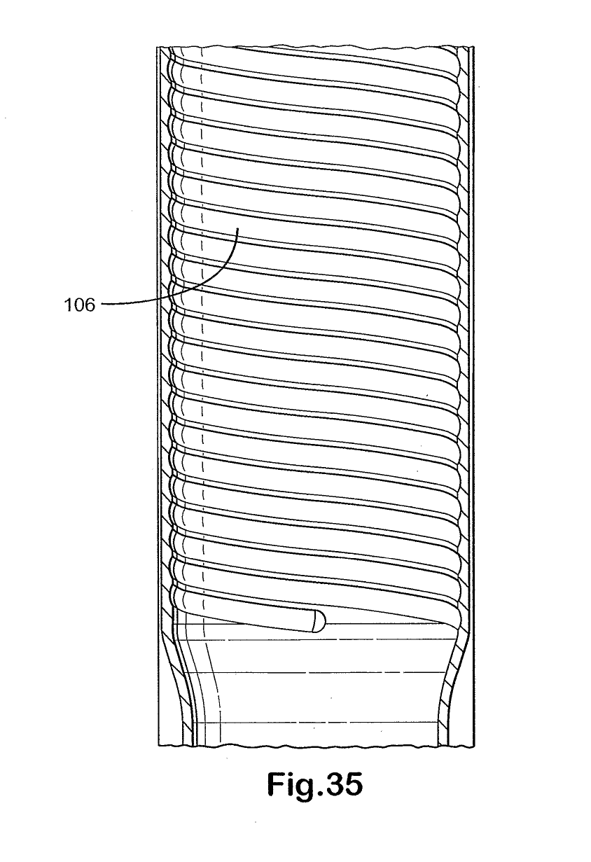

FIG. 35 shows a section of casing expanded using the ball bearing roller illustrated in FIGS. 33 to 34 having a corrugated profile.

FIGS. 1 to 8 illustrate a flush (i.e. no upset) connection according to the present invention and a method of preparing the connection. FIG. 1 is a side elevation of a first tubular element 1 having a pin 2, which has the form of a stepped taper. This tapered profile, when stabbed into the box of a second tubular element having a complementary stepped, tapered surface, and expanded forms a flush connection. This profile provides a tapered fit, and increases the ultimate tensile strength of the flush jointed connection to close to that of the tensile strength of the virgin pipe. At least some of the surfaces 4 of the steps of the tapered end 2 are plasma sprayed with a hard angular material. Preferably, these surfaces 4 have protuberances (not shown) of hard angular material; such as can be formed by the use of a mask during the plasma spraying. Plasma spraying the surface to deposit a hard angular material, such as tungsten, enhances the friction of the surface. Other surfaces of the tapered end 2 may also be surface coated. For example, to improve the sealing capability of the connection, the surfaces 5 could be treated by plasma spraying a soft metal, such as, for example, tin or copper and a thin elastomeric layer may be applied to surface 3.

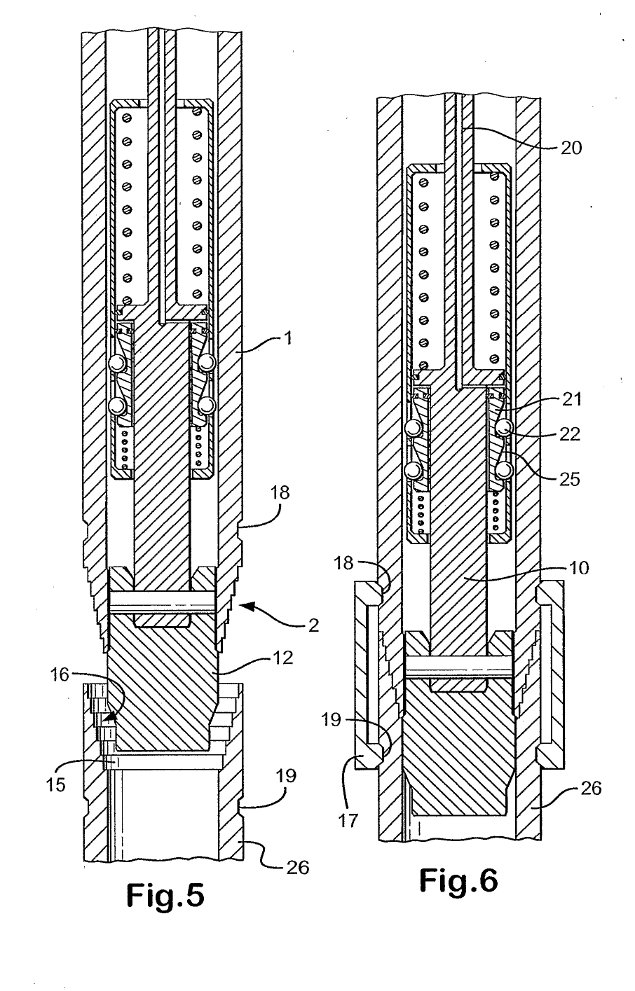

FIG. 9 is a schematic representation of equipment that can be used to handle tubular elements on an oil or gas rig. A section of pipe (e.g. the first tubular element 1 of FIG. 1) is picked up using a conventional travelling block arrangement 6. During this operation, a swaging tool 7 is lowered down the pipe's internal diameter using an umbilical 8 and winch 9. The suspended pipe is then positioned over a second pipe (the tubular element 26 of FIGS. 5 to 8). The second pipe is shown in FIG. 9 to be held at the rig floor by slips.

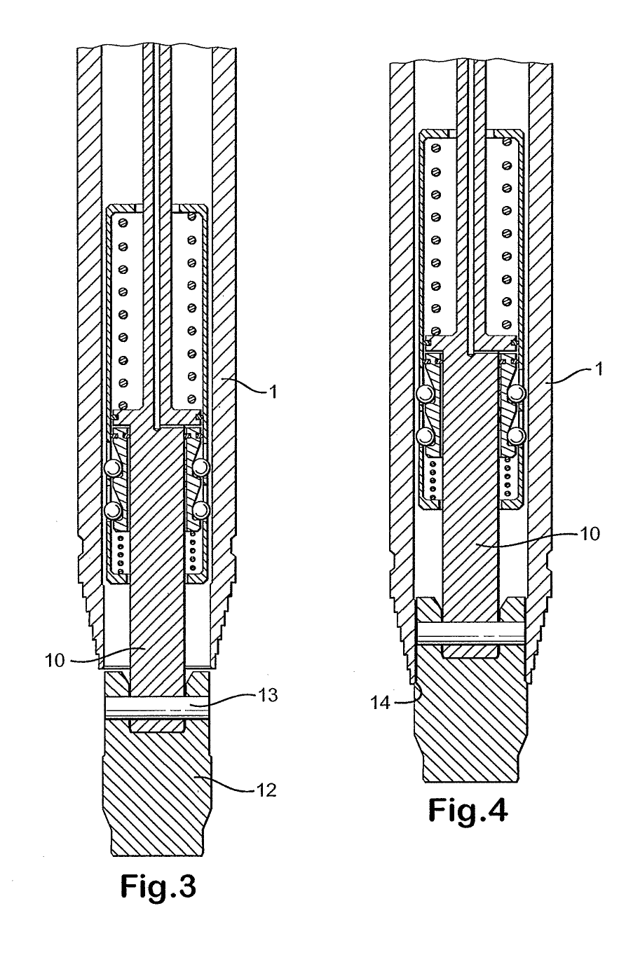

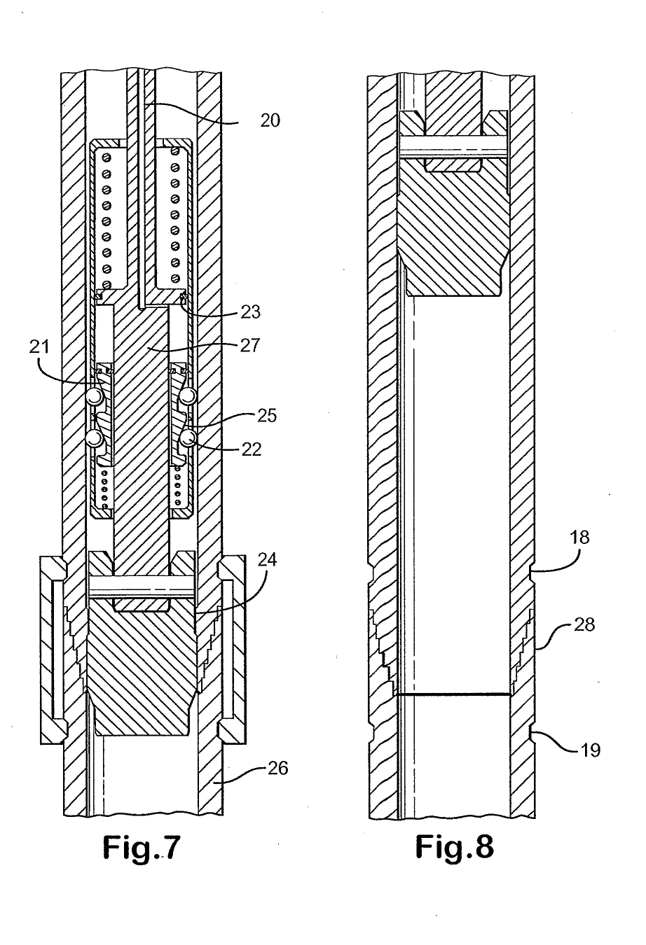

The method for stabbing the pin 2 of the tubular element 1, shown in FIG. 1, into a second tubular element 26 and making up the connection between the tubular elements is illustrated in more detail in FIGS. 2 to 8. In FIG. 2, the lower end 10 of the power section of the expander tool extends from of the lower end 11 of the tubular element 1. When sufficiently exposed a swaging die head 12 is attached to 10 using pin 13 as shown in FIG. 3. This assembly is then pulled up to a snug contact with the face to be expanded 14 as shown in FIG. 4. The assembly can then be stabbed into the flush jointed box 15 as shown in FIG. 5, until the faces of the box and pin come together as shown in FIG. 6. The box 15 has a stepped profile 16 corresponding to that of pin stepped profile 2. However, it can be seen in FIG. 6 that the internal diameters of the first tubular element 1 and the second element 26 are substantially the same, except that the internal diameter of the pin of the first element is slightly smaller. A clamp 17 can then be installed, which locates in grooves 18 and 19 on the box and pin and temporarily holds the connection together while the swaging operation is being performed. In FIG. 7, hydraulic pressure is applied down control line 20, energizing piston 21 forcing it downwards. A series of balls 22 are trapped against the piston's tapered surfaces 25, and the piston's downward motion forces these balls 22 radially outwards, firmly gripping the inner surface of the tubular element 1. The balls 22 do not mechanically score or damage the inner surface of the tubular element 1. Once piston 21 is lodged against the inner surface of the tubular element 1, the hydraulic pressure overcomes the sealing capacity of seal 23, which results in the body 27 being urged upwardly away from the piston 21, which is anchored by balls 22. The swaging head 12 is attached to the piston body 27, such that as the body 27 is forced upwardly, the swaging head 12 expands the inner surface of the pin connection 24. FIG. 8 shows that on completion of the piston stoke the hydraulic pressure drops off providing an indication to the operator that the swaging is completed. There is a slight recovery of the strain, but a visible increase in the external diameter in this embodiment is evident 28 and can be measured for quality assurance. The internal diameter of the pin section is shown in FIG. 8 to be substantially the same as the internal diameter of the rest of the first tubular element 1 and substantially the same as the internal diameter of the second tubular element 26, i.e. the connected tubular elements form a “monobore”. The temporary clamp 17 can be removed from the completed connection.

Referring once again to FIG. 9, as the travelling block 6 lowers the tubing string comprising the connected tubular elements 1 and 26 into the well, the umbilical 8 and swaging tool 7 are winched out of the top 29 of the tubing sting and are then ready to be lowered into the next tubular element to be picked up and connected to the tubing string in the well.

FIG. 10 illustrates an assembly process (in particular a swaging tool 30) being applied to the lower end of a coiled tubing string 31, typically at a well surface.

FIGS. 11 to 13 illustrate an alternative embodiment of a first tubular element 32 having a pin connector end 33. FIG. 11 is a side elevation of a first tubular element 32 having a pin 33 and FIG. 12 is a cross section along A-A of FIG. 11. The pin 33 of the tubular element 32 may have been formed by reducing the end of the pipe using conventional swaging dies. Protuberances 34 have been formed on the pin by plasma spraying with a hard angular material such as chromium or tungsten. The protuberances 34 may have been formed using a mask. In a process for forming the protuberances using a mask, the mask (not shown) is positioned over at least part of the reduced pin end 33 of the first tubular element 32. The mask may be, for example, a thin aluminium metal sheet with circular holes substantially uniformly distributed over it. The hard angular material plasma sprayed over the mask passes through to deposit and bond to the base pipe. The mask is then removed from around the pin 33 and raised protuberances 34 are left as shown in more detail in FIG. 13 which shows an expanded view of section B of FIG. 12. The plasma sprayed protuberance 34 is shown on the bare metal 36 of the pin. The protuberances 34 comprise a small step of hard material. When the pin 33 is expanded the protuberances embed themselves into the internal surface of the second tubular element and form strong anchor points for tension, compression, torsion and bending resistance. Instead of placing the mask over the bare metal of the pin, it is possible to first coat the pin, for example by plasma coating and then form the protuberances onto this coating.

Once this coupling is made up it cannot be broken in the manner of a threaded connection. It would generally be necessary to cut away the connection to separate the tubular elements.

As shown in FIGS. 11 and 12, the nose 35 of the pin 33 remains uncoated. Such a bare metal section of the pin 33 can provide a metal-t-o-metal seal when expanded into a correspondingly uncoated section of a box of a second tubular element (not shown).

The first tubular element 32 illustrated in FIG. 11 can be coupled with a second tubular element (not shown) by locating the pin portion 33 of the first tubular element 32 within a portion of the second tubular element and expanding the pin 33 to form a connection resulting from the interference between the pin having the plasma sprayed protuberances on its surface and the internal surface of the second tubular element. Any suitable means can be employed for expanding the pin of the first tubular element such as that shown in FIGS. 2 to 8 FIGS. 14 and 15, illustrate a connection according to the present invention used as a liner hanger. The first tubular element 37 has plasma sprayed protuberances 38 on a portion of its external surface and a bare metal portion 39. As shown in FIGS. 14 and 15, the connecting portion of the first tubular element 37 has been located within the second tubular element 40 and expanded such that the protuberances 38 are pressed against and are embedded in the internal surface of the second tubular element 40, forming the connection. A metal-to-metal pressure seal is formed in the region of the bare metal portion 39. It is possible after forming the liner hanger connection to further expand the liner, including the connection.

FIGS. 16 and 17 illustrate the use of a relatively short coupling 43 to join together two pipes 41 and 42 of a string. The coupling 43 is a male/male coupling having two “pin” ends 44 and 45. Thus, the pin end 45 can be considered a first tubular element and the pipe 41 its corresponding second tubular element and the pin end 45 can be considered another first tubular element and the pipe 42 its corresponding second tubular element. Prior to assembly, the external surface of the portions of the first tubular elements, i.e. the pins 44 and 45, and/or the internal surface of the portions of the second tubular elements, i.e. the pipes 41 and 42, are at least partially coated by plasma spraying with hard angular material. Preferably, protuberances (not shown) of hard, angular material are formed on the surfaces. The coupling 43 has a central stop 49. The pipes 41 and 42 can be butted up against the stop when making up the connection to ensure good alignment of the coupling 43 and pipes 41 and 42. The stop could if desired have a diameter substantially the same as, larger or (as shown) smaller than the external diameters of the pipes 41 and 42. The connection can be made up by pushing the two pipes 41 and 42 onto the male/male coupling 43. The internal surface of the male/male coupling 43 is then swaged radially outwards using a swaging tool, resulting in an expanded internal diameter of the coupling 43. The internal tapers 46 shown on the ends of the pins 44 and 45 assist in creating relatively smooth external deformations 47 of the pipes 41 and 42. The result is an external upset interference fit coupling. The connector many be partially expanded at surface to meet the required tensile and torque loads and then run in hole and then be fully swaged as required.

FIG. 18 shows an expanded connection similar to that shown in FIG. 17 except for the shape of the pins 44 and 45. The pins 44 and 45 shown in FIG. 1,6 are substantially cylindrical and the wall thickness is substantially constant (apart from at the tapered ends 46), i.e. the internal and external surfaces are substantially parallel, and, as illustrated in FIG. 17, remain substantially parallel after expansion of the connection. In contrast, the pins of FIG. 18 have a tapered wall thickness. The wall thickness of each of the pins 44 and 45 in FIG. 18 are thicker towards their distal ends than adjacent the central stop 49. The pins would initially have substantially right cylindrical external surfaces and frusto conical internal surfaces that tapered inwardly towards their distal ends. They would therefore have sufficient clearance to be inserted easily into the ends of the pipes 41 and 42. As shown in FIG. 18, after expansion the tapers are reversed such that the internal surface is a right cylinder and the external surfaces are tapered from the thickest sections 48 adjacent the distal ends towards the stop 49. The arrangement provides an expanded connection that has a greater resistance to being pulled apart.

FIGS. 19 and 20 illustrate the use of a relatively short coupling 50 to join together two pipes 41 and 42 of a string. The connecter 50 is a female/female coupling having two “box” ends 52 and 53. Thus, the pipe 41 can be considered a first tubular element and the box end 52 its corresponding second tubular element and the pipe 42 can be considered another first tubular element and the box end 53 its corresponding second tubular element. Prior to assembly, the external surface of the portions of the first tubular elements, i.e. the pipes 41 and 42, and/or the internal surface of the portions of the second tubular elements, i.e. the boxes, 52 and 53, are at least partially coated by plasma spraying with bard angular material. Preferably, protuberances (not shown) of hard, angular material are formed on the surfaces. The coupling 5 0 has a central stop 54. The pipes 41 and 42 can be butted up against the stop when making up the connection to ensure good alignment of the coupling 50 and pipes 41 and 42. The connection can be made up by pushing the two pipes 41 and 42 into the female/female coupling 50. The internal surfaces of the pipes 41 and 42 are then swaged radially outwards using a swaging tool. The expansion of the portions of the pipes 41 and 42 can, for example, be achieved using a rolling ball expander that forms a helical depression 51 on the internal surface as indicated in FIG. 20. The external diameter of the expanded portion of the pipes 41 and 42 is expanded from its original diameter to a larger diameter, recovering slightly after the expanding tool has completed its pass. The corrugations 51 are purposefully formed on the inside of the pipes 41 and 42 by the rotating ball bearing swaging tool. These corrugations can increase the collapse rating of the connection. In another embodiment of this invention these corrugations are formed on the inner surface of the pipes 41 and 42 along their entire length. This can increase the collapse rating of the whole pipe.

FIGS. 21 and 22 illustrate another connection, before and after expansion that employs both a male/male coupling 43 and a female/female coupling 50 to connect two pipes 41 and 42. The pipes 41 and 42 are located over the pins of a male/male coupling 43 of the type illustrated in FIG. 16 and into the boxes of a female/female coupling 50 of the type illustrated in FIG. 19. This provides increased surface are for torsional and tensile strength for the swaged connection.

FIGS. 23 and 24 illustrate a connection similar to that shown in FIGS. 16 and 17, except that helical thread inserts 55 are positioned between the external surfaces of the pins 44 and 45 and the internal surfaces of the pipes 41 and 42. The helical thread inserts increase the torsional and/or tensile strength of the connection. One example of a suitable helical thread insert 55 is commercially available under the trade name HELICOIL (Registered trade mark). Advantageously, the helical insert has a diamond cross-section as shown. When the connection is expanded, the helical thread insert 55 is embedded into both surfaces as indicated in FIG. 24. Such a connection can have a relatively high tensile strength.

The expanded connection shown in FIGS. 25 and 26 is similar to that shown in FIG. 22, except that like the connector shown in FIGS. 23 and 24 helical thread inserts 55 are positioned between the external surfaces of the pins 44 and 45 of the male/male coupling 43 and the internal surfaces of the pipes 41 and 42. In addition, and in order to further increase the torsional strength, lengths of inserts 56 are positioned, axially with respect to the longitunal axis of the pipes and couplings, between the external surfaces of the pipes 41 and 42 and the internal surfaces of the boxes 52 and 53 of the female/female coupling 50. Like the helical thread inserts, these may also advantageously have a diamond cross-section. Expansion of the connections causes the inserts 56 to become embedded in the mating surfaces and act to spline together the female/female coupling 50 and the pipes 41 and 42.

In each of the embodiments illustrated in the accompanying Figures relatively small amounts of expansion have been shown. However, the protuberances of plasma sprayed hard angular material that are preferably used in the connections according to the present invention, can accommodate relatively large expansions of the base pipe, while performing all the tensile, compression, torsion and bending functions required.

FIGS. 27 to 30 illustrate the use of an over-coupling protector. Often cables and control lines have to be attached to the outside of a completion tubing or other tubular string. Attaching such cables and control lines to the string may present difficulties and be expensive and/or time consuming. In particular, assembling attachment means capable of accommodating a greater diameter at the point of a connection between lengths of tubular, especially an expandable coupling, can be difficult. The over-coupling protector shown in FIGS. 27 to 30 is shaped and energized by the swaging process. Once the two tubes 41 and 42 have been stabbed together a sheet steel wrap 57 is put around the coupling and power cable 58, the ends of the sheet steel wrap 57 are clipped together by interlinking the folded-over ends 59. This gives quite a snug fit prior to the swaging process. As the coupling (not shown) is swaged, the over-coupling protector 57 is itself expanded as shown at 60, so forming an over-coupling protector for the cable 58. This has two benefits; it holds the cable 58 snug to the coupling, and because it clamps the cable 58 firmly on both sides of the coupling it provides an anchor to support the vertical load of the cable.

FIG. 31 shows an internal male/male coupling 99 and an external female/female coupling 100, which is perforated to enable flow to pass through its entire length, while being able to connect sections of sand screen 97, 98 together and support their tensile load.

FIGS. 32 to 35 illustrate the use of a preferred ball bearing roller expander. The ball bearing roller expander 104 is shown in FIG. 32 is in its undeployed mode, i.e. the ball bearing rollers are retracted within the outer wall to enable the expander to pass through the tubular element to be expanded. FIG. 33 illustrates the expander in its deployed mode. A cone 101 within the housing of the expander 104 has been displaced which causes the radial extension of the arms 103 at each end of which is mounted the ball bearing rollers 102. The amount the piston is displaced causes a proportional displacement of the arms carrying the ball bearing rollers 102 and hence the final expansion which will be achieved. In expanding a tubular element 105, the body 104 is rotated, whilst it is simultaneously advanced along the axis of the tubular element 105. The axial motion is controlled such that the expansion process forms a helical corrugation 106 on the internal surface of the tubular element 105. This process can be performed downhole or before the tubular element is located in the well. This effect can be increased to create corrugations 106 on inside and outside surface of the expanded tube 105. This can both strengthen a thin walled tube which has been expanded and increase its collapse rating, or it can provide a ideal profile to locate additional support for the expanded thin wall tube.

1-10. (canceled)

11. A method for connecting a first tubular element and a second tubular element comprising:
locating a portion of the first tubular element within a portion of the second tubular element,
expanding the portion of the first tubular element and/or compressing the portion of the second tubular element to form a connection resulting from the interference between the external surface of the portion of the first tubular element and the internal surface of the portion of the second tubular element,
in which, prior to assembly, one or both of the external surface of the portion of the first tubular element and the internal surface of the portion of the second tubular element is/are at least partially coated with hard angular material, characterised in that the hard angular material is applied to the external surface of the portion of the first tubular element and/or the internal surface of the portion of the second tubular element by plasma spraying to form protuberances on the surface.

12. A method as claimed in claim 11 in which a mask is used to form the protuberances.

13. A method as claimed in claim 12 in which a foraminous mask is placed over at least part of the external surface of the portion of the first tubular element and/or part of the internal surface of the portion of the second tubular element before the surface is sprayed such that the plasma spray passes through holes in the mask, forming protuberances on the surface of the surface when the mask is removed.

14. A method as claimed in claim 11 in which part of the portion of the first tubular element and a corresponding part of the portion of the second tubular element are not coated by plasma spraying such that when the connection is expanded these bare metal parts form a metal-to-metal seal.

15. A method as claimed in claim 1 1 in which two pipes are connected by locating one end of each of the pipes over a pin of a male/male connector and within the box of a female/female connector and expanding the internal diameter of the male/male connector.

16. A method as claimed in claim 11 in which at least one element designed to be embedded in the surfaces as the connection is expanded is located between the external surface of the portion of the first tubular element and/or part of the internal surface of the portion of the second tubular element.

17. A method for connecting piping used in oil and gas boreholes comprises connecting pipes together as claimed in claim 11, lowering the pipe string into the borehole and subsequently radially expanding the pipe string downhole.

18. An expandable tubular element suitable for forming connections by a method as claimed in claim 11 having protuberances on a part of its surface adjacent at least one end thereof which have been formed by plasma spraying a hard angular material.

19. An expandable tubular element as claimed in claim 18 which is a male/male coupling comprising two pin connectors the plasma sprayed protuberances being on the external surfaces of the pin connectors.

20. An expandable tubular element as claimed in claim 18 which is a female/female coupling comprising two box connectors the plasma sprayed protuberances being on the internal surfaces of the box connectors.
